(19) United States
(12) Patent Application Publication
(10) Pub. No.: US 2003/0210040 A1
(43) Pub. Date: Nov. 13, 2003

(54) Permeability detection system of ferrite core using magnetic field induction method

(75) Inventors: Byung Hoon Kang, Seoul (KR); Sang Hoon Song, Suwon-Shi (KR); Gab Yong Kim, Seoul (KR)

Correspondence Address: DARBY & DARBY P.C., 805 Third Avenue, New York, NY, 10022, US

(73) Assignee: SAMSUNG ELECTRO-MECHANICS CO., LTD., Suwon-Shi (KR)

(21) Appl. No.: 10/269,937

(22) Filed: Oct. 11, 2002

(30) Foreign Application Priority Data
May 8, 2002 (KR) 2002-25344
May 8, 2002 (KR) 2002-25345
May 8, 2002 (KR) 2002-25347

(51) Int. Cl. G01N 27/72

(52) U.S. Cl. 324/228

(57) ABSTRACT

The present invention relates generally to a system for measuring dispersion degree of a ferrite core of components of a deflection yoke, and more particularly to a permeability detection system of a ferrite core using a magnetic field induction method which extracts inferior ferrite cores by measuring a characteristic of the ferrite core through a winding wire and by detecting the dispersion degree of the ferrite core, during its production operation.

The permeability detection system of the present invention can detect the permeability of each part of the sample ferrite core, and compares it with the reference ferrite core to easily distinguish the inferiority of the ferrite core, thus increasing a productivity of the ferrite core and improving its reliance.

### BACKGROUND OF THE INVENTION

1. Field of the Invention

The present invention relates generally to a system for measuring dispersion degree of a ferrite core of a deflection yoke, and more particularly to a permeability detection system of a ferrite core using a magnetic field induction method, which extracts inferior ferrite cores by measuring a characteristic of the ferrite core through a winding wire and by detecting the dispersion degree of the ferrite core, during its production operation.

2. Description of the Related Art

Generally, a main parameter of a deflection yoke will be a deflection property. One of the most important components to determine this deflection property is a ferrite core, and so permeability or dispersion degree is a major characteristic to determine the property of the deflection yoke.

Therefore, work to measure the permeability of the ferrite core is very important for a manufacture process of the deflection yoke, and however a specific method does not exist which professionally measure the permeability of the ferrite core, and a method of measuring magnetic properties of a high frequency wave has been largely suggested.

The method of measuring the magnetic properties of a high frequency wave is largely distinguished into an analog method and a digital method. The analog method, a classical method is to read a voltage after approximately converting it into a magnetic value by using a general oscilloscope, and it is impossible in this method to save or computerize the measured data.

Additionally, in case of the high frequency wave, a record for waveforms should be performed in a shortest time in order to prevent a heat radiation of a sample, and so a measurement for high frequency waves above several kHz is difficult in the analog method, where a saving of measurement data or a computer control is impossible to perform.

Accordingly, a measurement of a magnetic hysteresis curve and the magnetic property of the high frequency wave, for example, core loss almost all employs the digital method.

Distinguishing minutely the digital method, there are a measurement method with an A/D converter interface card and a high speed data bus in a computer, a method of using a digital oscilloscope, a method of recording waveforms using an exclusive digitizer, a method of measuring only the core loss by applying a digitizing function into a wattmeter, and a measurement method with a unified measurement apparatus on which a high speed A/D converting circuit and a signal generator are mounted.

The measurement method with the A/D converter interface card and the high speed data bus in the computer and the method of recording waveforms using the exclusive digitizer has a high vertical decomposition ability, and so due to a limitation of its sampling rate the measurement for high frequencies above MHz is difficult and its fabrication cost is high.

Additionally, the wattmeter using a digitizing method digitizes signals by an internal A/D converter to measure the core loss up to several hundred kHz, and this is disadvantageous in that the waveform in the magnetic hysteresis curve cannot be measured.

Additionally, the method of using the digital oscilloscope first records signal waveforms to an oscilloscope and processes the waveforms in a computer to achieve the waveform in the magnetic hysteresis curve. The measurement method with a unified measurement apparatus on which a high speed A/D converting circuit and a signal generator are mounted unifies an oscilloscope function and a computer function to select only necessary functions. In order to measure the core loss and the magnetic hysteresis curve for frequencies above MHz, we have no alternative choice but to employ these two systems.

Therefore, work of measuring the permeability of the ferrite core during a production process is not easy in the existing digital measurement method, and a development of a sensor and a system for measuring the permeability and the ferrite core is deeply needed.

A related detection system of the magnetic properties of the high frequency wave using the digital method (Korean Patent No. 10-0231887) which was suggested to solve the above problems will be briefly described.

FIG. 1 is a block diagram for showing a structure of the conventional detection system. The detection system comprises a signal generator 1 for receiving a parameter for a measurement condition of a sample 3 from a computer 8 and outputting a signal waveform corresponding to the measurement condition; an amplifier 2 for amplifying the signal waveform outputted from the signal generator 1; a shunt 7 for outputting a H magnetic field-voltage waveform by converting current of a primary coil 4 of the sample 3; a digital oscilloscope 6 for receiving the H magnetic field-voltage waveform converted from the shunt 7 through a channel No. 1 and a B magnetic field-voltage waveform induced at a secondary coil 5 of the sample 3 through a channel No.2, and for sampling the inputted high frequency waveform of each channel in the digital way and saving them in its memory, and for analyzing the voltage of the high frequency waveform of each channel to measure the core loss, magnetic values and the magnetic hysteresis curve at a desired frequency and an magnetic flux density according to a measurement condition of the sample 3; a computer 8 for managing and controlling the whole system which feeds back an output of the signal generator 1 and a measurement value of the digital oscilloscope 6 and finally determines the output of the signal generator 1 in order to receive the parameters about the measurement condition and to obtain waveforms corresponding the measurement condition, and commands the digital oscilloscope 6 to respectively save voltage waveforms corresponding to the H magnetic field and the B magnetic field resulting from the determined signal of the signal generator 1, and retrieves the saved waveforms into a memory in the computer to obtain the H/B waveforms and the magnetic hysteresis curve of the high frequency wave through a numerical calculation such as an integral; a GPIB cable 9 which is connected between the digital oscilloscope 6 and a communication interface GPIB (General Purpose Interface Bus) of the computer which is for a communication of numerical data and serial control commands, and which is connected between the GPIB and the signal generator.

An operation of the conventional system constructed as above is as follows.

When the signal generator 1 outputs a signal, the amplifier 2 amplifies the signal, and the amplified current flows into the primary coil 4 of the sample 3 to generate a H magnetic field. A B magnetic Field is created at the sample 3 by the H magnetic field, and so an induced voltage is generated at the secondary coil 5. To channel No.1 of the digital oscilloscope 6 is inputted a voltage converted from the current of the primary coil 4 through the shunt 7, and to the channel No.2 is inputted the induced voltage of the secondary coil 5.

The digital oscilloscope 6 performs a sampling of a high frequency waveform of each channel in a digital way to save the sample waveform in its memory, and analyzes a voltage of the high frequency waveform of each channel to measure the core loss, magnetic values and the magnetic hysteresis curve at a desired frequency and a magnetic flux density according to the measurement condition of the sample 3.

The computer 8 manages and controls each measurement process of the whole system. First, the computer 8 feeds back an output of the signal generator 1 and a measurement value of the digital oscilloscope 6 and finally determines the output of the signal generator 1 in order to receive the parameters about the measurement condition from a user and to obtain waveforms corresponding the measurement condition.

Additionally, the computer 8 commands the digital oscilloscope 6 to respectively save voltage waveforms corresponding to the H magnetic field and the B magnetic field resulting from the determined signal of the signal generator 1, and retrieves the saved waveforms into a memory in the computer to obtain the H/B waveforms and the magnetic hysteresis curve of the high frequency wave through a numerical calculation such as an integral.

A transfer of these serial control commands and numerical data is performed through the internal GPIB (General Purpose Interface Bus) of the computer 8 and the GPIB cable 9 which is connected to the signal generator 1 and the digital oscilloscope 6.

FIG. 2 is a view of showing a B-H curve to measure the ferrite core at an operation magnetic flux density 0.1 T and a 1 MHz frequency by using the above system.

Here, the above conventional method aims at measuring the permeability of any material by obtaining the B-H curve, and it has many problems to extract inferior ferrite cores by measuring a characteristic of the ferrite core through a winding wire and by detecting a dispersion of the ferrite core, during its production operation.

Therefore, the present invention does not use the B-H curve like the above mentioned related prior art, but directly applies a uniform magnetic field to a certain position of the ferrite core and measures the dispersion of the magnetic field which passes the ferrite core, thus avoiding a complex structure of the measuring sensor and the measuring system which a demerit of the above prior art.

Specially, existing ferrite cores are distinguished into a soft ferrite and a hard ferrite, and the ferrite cores, which are used in the deflection yoke, are soft type cores, and important properties of the ferrite core depend on their permeability.

The ferrite core which is nowadays used in the deflection yoke should be a ferrite core having a uniform distribution of the permeability having no dispersion, but actually the dispersion of the permeability cannot be completely eliminated. Accordingly, a development of a measurement apparatus of the ferrite core that can measure and detect the dispersion is desired. That is, a process, in which an assembly and component dispersion of the DY is decreased by obtaining the magnitude of the permeability of the ferrite core and measuring the dispersion according to parts of the ferrite core to detect inferiority of the ferrite core, is desired.

### SUMMARY OF THE INVENTION

Accordingly, the present invention has been made keeping in mind the above problems occurring in the prior art, and an object of the present invention is to provide a system for measuring dispersion degree of a ferrite core of components of a deflection yoke, and more particularly a permeability detection system of a ferrite core using a magnetic field induction method which extracts inferior ferrite cores by measuring a characteristic of the ferrite core through a winding wire and by detecting the dispersion degree of the ferrite core, during its production operation.

To achieve the above object, there is provided a permeability detection system of a ferrite core using magnetic field induction method, comprising: an oscillator for generating an alternating current voltage of a predetermined frequency bandwidth; a permeability detector for receiving the alternating current voltage of the specific frequency bandwidth generated from the oscillator to form a magnetic field, and detecting a changed amount of the formed magnetic field via the ferrite core; an amplifier for amplifying a signal detected at the permeability detector; a band pass filter for eliminating noise from the signal amplified by the amplifier; a digital signal producer for receiving the signal with noise eliminated from the band pass filter to convert into a digital signal; and a computer for displaying data from the digital signal producer on a monitor according to pattern type and saving the data if necessary to be utilized as a study material for the permeability of the ferrite core.

The permeability detector comprises an AC generator for receiving the alternating current voltage of the specific frequency bandwidth generated from the oscillator to form a magnetic field; and a magnetic sensor for changing current amount according to a changed amount of the formed magnetic field via the examined ferrite core.

In another aspect of the present invention, there is provided a permeability detection system of ferrite core using magnetic field induction method, comprising: an oscillator for generating an alternating current voltage of a predetermined specific frequency bandwidth; a permeability detector, wounded around a “∃” shaped examining ferrite core having a uniform permeability, for receiving the alternating current voltage of the specific frequency bandwidth generated from the oscillator to form a magnetic field along the examining ferrite core, and detecting a changed amount of the formed magnetic field via the ferrite core to be examined; an amplifier for amplifying a signal detected at the permeability detector; a band pass filter for eliminating noise from the signal amplified by the amplifier; a digital signal producer for receiving the signal with noise eliminated from the band pass filter to convert into a digital signal; and a computer for displaying data from the digital signal producer on a monitor according to pattern type and saving the data if necessary to be utilized as a study material for the permeability of the ferrite core.

The permeability detector comprises an AC generator, wounded around a central projection of the examining ferrite core, for receiving the alternating current voltage of the specific frequency bandwidth generated from the oscillator to form a magnetic field; and a magnetic sensor, wounded under the AC generator, for changing current amount according to a changed amount of the formed magnetic field via the examined ferrite core.

In yet another aspect of the present invention, there is provided a permeability detection system of ferrite core using magnetic field induction method, comprising: an oscillator for generating an alternating current voltage of a predetermined specific frequency bandwidth; a permeability detector, positioned in a flux of a magnetic resulting from a horseshoe shaped magnet (not shown), for receiving the alternating current voltage of the frequency bandwidth generated from the oscillator and for detecting a changed amount of the magnetic field which passes a sample ferrite core after being generated from the horseshoe shaped magnet; an amplifier for amplifying a signal detected at the permeability detection system; a digital signal generator for receiving the signal amplified by the amplifier to convert it to a digital after a signal process; and a computer for displaying data from the digital signal generator on its monitor according to any pattern and for saving the data if necessary to be utilized as a study material for the permeability of the ferrite core.

The permeability detector comprises a horseshoe shaped magnet for forming a magnetic field; and a hole sensor, which is positioned in a flux of the magnetic field resulting from the horseshoe shaped magnet, for receiving the alternating current voltage of the specific frequency bandwidth generated from the oscillator and for detecting a changed amount of the magnetic field which passes the sample ferrite core after being generated from the horseshoe shaped magnet.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an illustrative view of showing a structure of a system for detecting a magnetic property for a high frequency wave according to a conventional digital measurement method;

FIG. 2 is a view of showing a B-H curve to measure the ferrite core at an operation magnetic flux density 0.1 T and a frequency 1 MHz by using the system in FIG. 1;

FIG. 3 is an illustrative view of showing a structure of the permeability detection system of ferrite core using magnetic field induction method of the present invention;

FIG. 4 is an illustrative view of showing a detail structure of the permeability detector in the detection system in FIG. 3;

FIG. 5 and FIG. 6 are illustrative views of showing positions of the magnetic sensor in the ferrite core;

FIG. 7 is an illustrative view of showing a detail structure of the permeability detector at the deflection system in FIG. 3;

FIG. 8 is an illustrative view of showing another embodiment of the permeability detection system of ferrite core using magnetic field induction method of the present invention; and

FIG. 9 is an illustrative view of showing a detail structure of the permeability detector at the deflection system in FIG. 8;

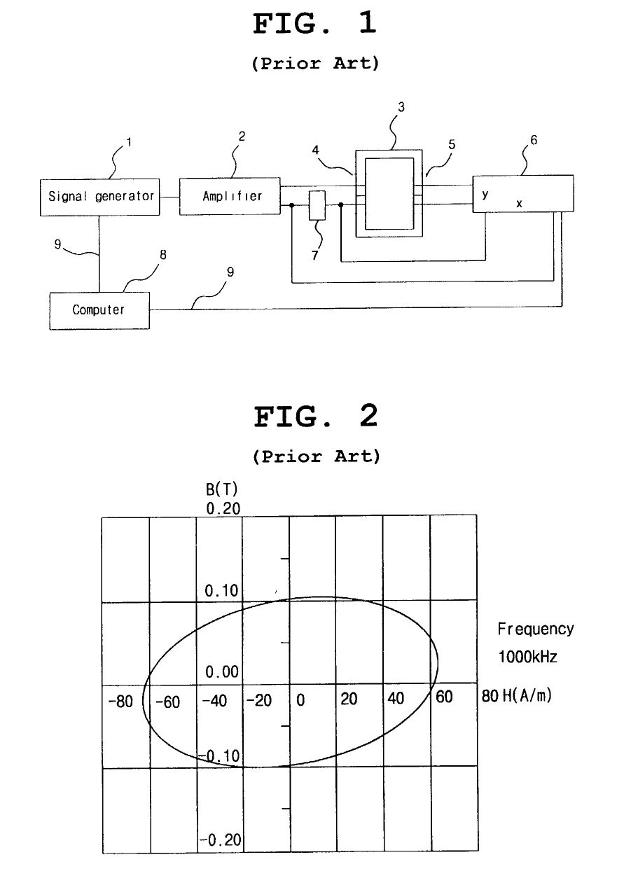

### DESCRIPTION OF THE PREFERRED EMBODIMENTS

Reference now should be made to the drawings, in which the same reference numerals are used throughout the different drawings to designate the same or similar components.

Hereinafter, preferred embodiments of the present invention are described in detail with respect to accompanying drawings.

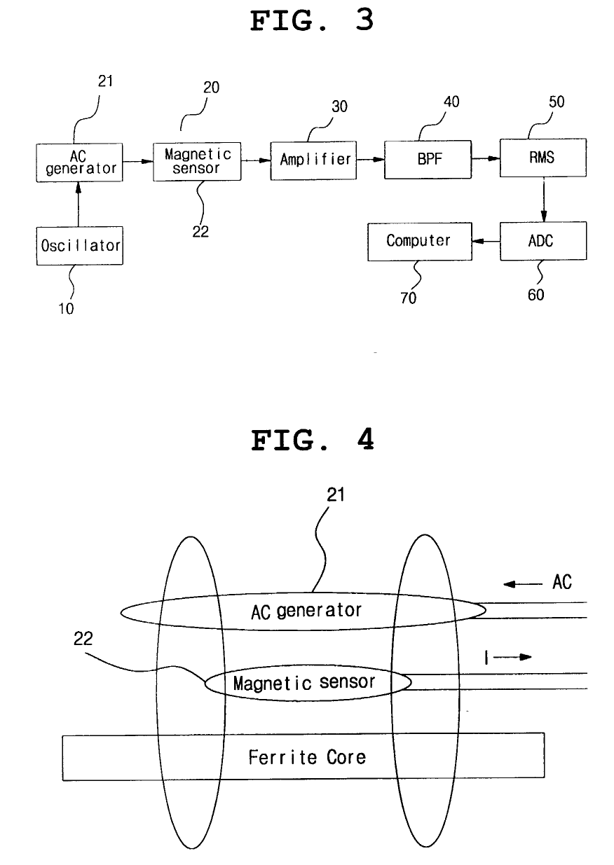

FIG. 3 is an illustrative view of showing a structure of the permeability detection system of ferrite core using magnetic field induction method of the present invention.

This detection system comprises an oscillator 10 generating an alternating current voltage of a predetermined specific frequency bandwidth; a permeability detector 20 for receiving the alternating current voltage of the specific frequency bandwidth generated from the oscillator 10 to form a magnetic field, and for detecting a changed amount of the formed magnetic field via the ferrite core; an amplifier 30 for amplifying a signal detected at the permeability detection system 20; a band pass filter (BPF; 40) for eliminating noise from the amplified signal by the amplifier; a Root Mean Square (RMS; 50) and a ADC 60 for receiving the signal with noise eliminated from the band pass filter to convert it to a digital signal; and a computer 70 for displaying data from the ADC 60 on its monitor according to any pattern and for saving the data if necessary to be utilized as a study material for the permeability of the ferrite core.

In the permeability detection system of ferrite core using magnetic field induction method of the present invention, a detail operation of the detector 20 for detecting the permeability detection system of ferrite core will be described with respect to FIGS. 4 to 6.

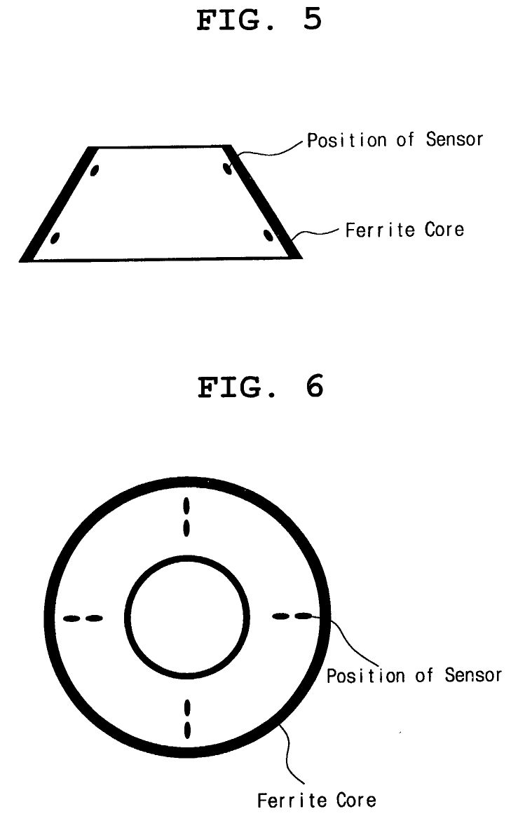

FIG. 4 is an illustrative view of showing a detail structure of the permeability detector in FIG. 3. FIG. 5 and FIG. 6 are illustrative views of showing positions of the magnetic sensor in the ferrite core.

The permeability detector 20, which includes an AC generator 21 and a magnetic sensor 22 in FIG. 4, is positioned at places as shown in FIG. 5 and FIG. 6. If the permeability of the ferrite core is uniform at its whole part, the amount of current flowing in the magnetic sensor 22 will be uniform, while the amount of current will not be uniform if the permeability of the ferrite core is not uniform with dispersion in its parts.

Then, the amount of current in the magnetic sensor 22 is converted into a digital amount by the ADC 60. The computer 70 recognizes and saves the converted current amount to display it on its monitor and measure the dispersion of the permeability, thus distinguishing an inferiority of the ferrite core.

Here, RMS 50 is a Root Mean Square and this is necessary to change AC signals to DC levels. When data to be digitized by the ADC 60 are inputted to the ADC 60, the data should be in a DC level, and so the RMS 50 serves to change a AC signal to a DC level.

Normally, a RMS and a ADC are together called as an A/D converter, and so a detail explanation about the explanation is omitted here.

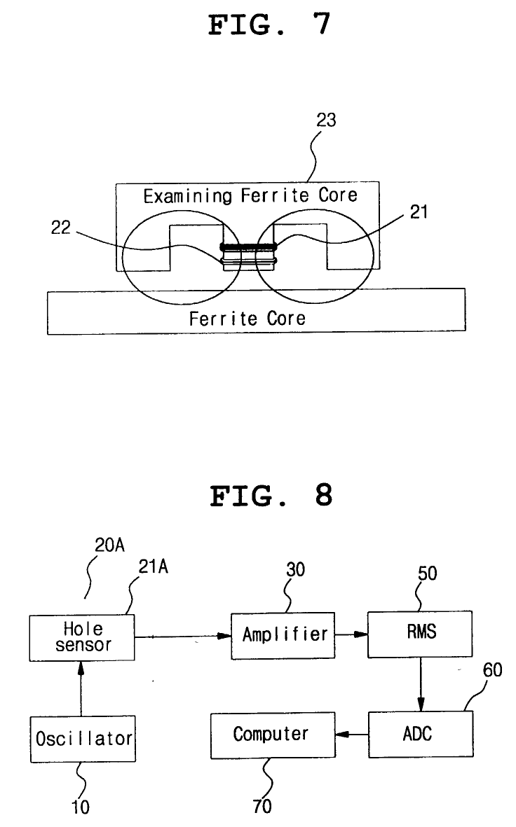

FIG. 7 is an illustrative view of showing a detail structure of another embodiment of the permeability detector at the deflection system in FIG. 3. This embodiment is a modification of the permeability detector 20 for a more stable detection of the permeability of the ferrite core.

That is, the permeability detector 20 having the AC generator 21 and the magnetic sensor 22 is positioned at places as shown in FIG. 5 and FIG. 6.

In the embodiment in FIG. 7, the AC generator 21 is wounded around a central projection of a “∃” shaped examining ferrite core 23 having a uniform permeability. A wounded magnetic sensor 22 is positioned under the AC generator.

Accordingly, a magnetic field resulting from the AC generator is concentrated by the examining ferrite core to form a uniform magnetic field. The examined ferrite core is positioned in the magnetic field. Here, a magnetic flux can be detected differently. Different magnetic fluxes according to a permeability rate can be detected at the examining ferrite core 23 having a uniform permeability and the examined ferrite core with unknown permeability. This is because the permeability of the examining ferrite core 23 and the examined ferrite core are different from each other. A permeability of a typical reference ferrite core is available, and so various permeability of the examining ferrite core was tested beforehand with the typical reference ferrite core.

Accordingly, the unknown permeability is detected by using a permeability rate. An amount of current flowing in the magnetic sensor 22 is changed according to a permeability rate of the examined ferrite core.

Here, if the permeability of the examined ferrite core is uniform at its whole part, the amount of current flowing in the magnetic sensor 22 will be uniform, while the amount of current will not be uniform if the permeability of the ferrite core is not uniform with dispersion in its parts.

Accordingly, this embodiment can produce a more stable magnetic field than the embodiment in FIG. 4, thus easily detecting the permeability.

FIG. 8 is an illustrative view of showing another embodiment of the permeability detection system of ferrite core using magnetic field induction method of the present invention, this embodiment improving a reliance of signal flow of the whole system and reducing its fabrication cost.

The detection system in FIG. 8 comprises an oscillator 10 generating an alternating current voltage of a predetermined specific frequency bandwidth; a permeability detector 20A, which is positioned in a flux of a magnetic field resulting from a horseshoe shaped magnet (not shown), for receiving the alternating current voltage of the specific frequency bandwidth generated from the oscillator 10 and for detecting a changed amount of the magnetic field which passes a sample ferrite core after being generated from the horseshoe shaped magnet; an amplifier 30 for amplifying a signal detected at the permeability detection system 20A; a RMS 50 and a ADC 60 for receiving the amplified signal by the amplifier 30 to convert it to a digital after a signal process; and a computer 70 for displaying data from the ADC 60 on its monitor according to any pattern and for saving the data if necessary to be utilized as a study material for the permeability of the ferrite core.

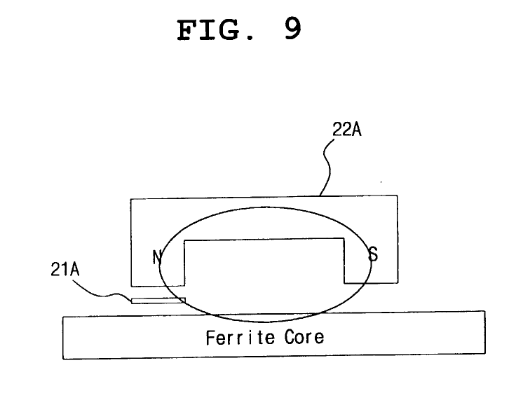

Now, a detail operation of the permeability detector 20A in the permeability detection system of ferrite core using magnetic field induction method of the present invention will be described with respect to FIG. 9. FIG. 9 is an illustrative view of showing a detail structure of the permeability detector of the permeability detection system in FIG. 8.

The permeability detector 20A, which includes a hole sensor 21A and the horseshoe shaped magnet 22A in FIG. 9, is positioned at the places as shown in FIG. 5 and FIG. 6. The permeability detector 20A comprises the horseshoe magnet 22A for forming a magnetic field; and the hole sensor 21A, which is positioned in a flux of a magnetic field resulting from the horseshoe shaped magnet (22A), for receiving the alternating current voltage of the specific frequency bandwidth generated from the oscillator 10 and for detecting a changed amount of the magnetic field which passes a sample ferrite core after being generated from the horseshoe shaped magnet.

Here, the detection method employs a method of detecting, by the hole sensor 21A, a flux being proportioned to the permeability of the ferrite core by a magnetic flux resulting from a N pole. The hole sensor 21A is positioned by using a source of current, thus eliminating effects resulting from noise by the oscillator 10.

As described above, the permeability detection system of ferrite core using magnetic field induction method of the present invention can detect the permeability of each part of the sample ferrite core, and compares it with the reference ferrite core to distinguish the inferiority of the ferrite core, thus increasing a productivity of the ferrite core and improving its reliance.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A permeability detection system of a ferrite core using magnetic field induction method, comprising:
an oscillator for generating an alternating current voltage of a predetermined frequency bandwidth;
a permeability detector for receiving the alternating current voltage of the specific frequency bandwidth generated from the oscillator to form a magnetic field, and detecting a changed amount of the formed magnetic field via the ferrite core;
an amplifier for amplifying a signal detected at the permeability detector;
a band pass filter for eliminating noise from the signal amplified by the amplifier;
a digital signal producer for receiving the signal with noise eliminated from the band pass filter to convert into a digital signal; and
a computer for displaying data from the digital signal producer on a monitor according to pattern type and saving the data if necessary to be utilized as a study material for the permeability of the ferrite core.

2. The permeability detection system according to claim 1, wherein the permeability detector comprises an AC generator for receiving the alternating current voltage of the specific frequency bandwidth generated from the oscillator to form a magnetic field; and a magnetic sensor for changing current amount according to a changed amount of the formed magnetic field via the examined ferrite core.

3. A permeability detection system of ferrite core using magnetic field induction method, comprising:
an oscillator for generating an alternating current voltage of a predetermined specific frequency bandwidth;
a permeability detector, wounded around a “∃” shaped examining ferrite core having a uniform permeability, for receiving the alternating current voltage of the specific frequency bandwidth generated from the oscillator to form a magnetic field along the examining ferrite core, and detecting a changed amount of the formed magnetic field via the ferrite core to be examined;
an amplifier for amplifying a signal detected at the permeability detector;
a band pass filter for eliminating noise from the signal amplified by the amplifier;
a digital signal producer for receiving the signal with noise eliminated from the band pass filter to convert into a digital signal; and
a computer for displaying data from the digital signal producer on a monitor according to pattern type and saving the data if necessary to be utilized as a study material for the permeability of the ferrite core.

4. The permeability detection system according to claim 3, wherein the permeability detector comprises an AC generator, wounded around a central projection of the examining ferrite core, for receiving the alternating current voltage of the specific frequency bandwidth generated from the oscillator to form a magnetic field; and a magnetic sensor, wounded under the AC generator, for changing current amount according to a changed amount of the formed magnetic field via the examined ferrite core.

5. A permeability detection system of ferrite core using magnetic field induction method, comprising:
an oscillator for generating an alternating current voltage of a predetermined specific frequency bandwidth;
a permeability detector, positioned in a flux of a magnetic resulting from a horseshoe shaped magnet (not shown), for receiving the alternating current voltage of the frequency bandwidth generated from the oscillator and for detecting a changed amount of the magnetic field which passes a sample ferrite core after being generated from the horseshoe shaped magnet;
an amplifier for amplifying a signal detected at the permeability detection system;
a digital signal generator for receiving the signal amplified by the amplifier to convert it to a digital after a signal process; and
a computer for displaying data from the digital signal generator on its monitor according to any pattern and for saving the data if necessary to be utilized as a study material for the permeability of the ferrite core.

6. The permeability detection system according to claim 5, wherein the permeability detector comprises a horseshoe shaped magnet for forming a magnetic field; and a hole sensor, which is positioned in a flux of the magnetic field resulting from the horseshoe shaped magnet, for receiving the alternating current voltage of the specific frequency bandwidth generated from the oscillator and for detecting a changed amount of the magnetic field which passes the sample ferrite core after being generated from the horseshoe shaped magnet.
